(19) United States
(12) Patent Application Publication
(10) Pub. No.: US 2004/0161235 A1
(43) Pub. Date: Aug. 19, 2004

(54) WDM-to-switch interface unit

(76) Inventors: Ross Halgren, Collaroy Plateau (AU); Richard Lauder, Earlwood (AU); James A. Donnelly, San Francisco, CA (US)

Correspondence Address: CHRISTIE, PARKER & HALE, LLP, P.O. BOX 7068, PASADENA, CA, 91109-7068, US

(21) Appl. No.: 10/395,406

(22) Filed: Mar. 24, 2003

(30) Foreign Application Priority Data
Feb. 14, 2003 (AU) 2003900693

(51) Int. Cl. H04J 14/00

(52) U.S. Cl. 398/45

(57) ABSTRACT

A WDM-to-switch interface unit comprising a WDM multiplexer/demultiplexer (mux/demux) for interfacing to a WDM optical network, a switch interface element for interfacing to an external switch unit, and a first conversion component disposed between the WDM mux/demux and the switch interface element for converting one or more layers of a management protocol in the optical network into corresponding layers of a management protocol of the external switch unit.

### FIELD OF THE INVENTION

The present invention relates broadly to a WDM-to-switch interface unit and to optical switching and transport networks.

### BACKGROUND OF THE INVENTION

There is a need to eliminate the current “book-end” approach to WDM network design that is associated with proprietary equipment protocols and management, to reduce the amount of equipment, rack space, interconnects, power and cost at Central Offices (CO)s & Point of Presence (PoP)s. The term “book-end” approach refers to the fact that the proprietary equipment has to be located at each end of a link.

The present invention seeks to address this need.

### SUMMARY OF THE INVENTION

In accordance with a first aspect of the present invention, there is provided a WDM-to-switch interface unit comprising a WDM multiplexer/demultiplexer (mux/demux) for interfacing to a WDM optical network, a switch interface element for interfacing to an external switch unit, and a first conversion component disposed between the WDM mux/demux and the switch interface element for converting one or more layers of a management protocol in the optical network into corresponding layers of a management protocol of the external switch unit.

Preferably, the interface unit further comprises a second conversion component disposed between the WDM mux/demux and the switch interface element for converting a data protocol of the optical network into a data protocol of the external switch unit and vice versa.

In one embodiment, the first conversion component comprises two separate converter elements, a first converter element for converting the one or more layers of the management protocol of the optical network into intermediate management signals and vice versa, and a second converter element for converting the intermediate management signals into the corresponding layers of the management protocol of the external switch unit and vice versa.

In one embodiment, the second intermediate conversion component comprise two separate converter elements, a first converter element for converting the data protocol of the optical network into intermediate data signals and vice versa, and a second converter element for converting the intermediate data signals into the data protocol of the external switch unit and vice versa.

The first conversion component may be arranged for converting the one or more layers of the one management protocol from an optical incoming signal into a corresponding electrical signal.

In one embodiment, the incoming optical signal is received as a optical supervisory channel signal in a demultiplexed WDM signal from the optical network.

In another embodiment, the incoming optical signal is received as an embedded supervisory signal on one or more of the channel signals of a demultiplexed WDM signal from the optical network.

The interface unit may further comprise a cross connect switching element disposed between the WDM mux/demux and the second conversion component, and an interconnection element connected to the cross connect switch, whereby the interface unit is adapted as an add/drop interface unit for ring based connectivity via the WDM mux/demux and the interconnection element.

The interface unit may be arranged for interconnection to another interface unit via the interconnection element.

The interconnection element may be in the form of an electrical interconnection.

The interconnection element may be in the form of an optical interconnection.

The interconnection element may be in the form of an additional WDM mux/demux.

The cross connect switching element may comprise an electrical switch.

The cross connect switching element may comprise an optical switch.

The other interface unit may be connected to the same external switch unit for a west-east redundancy ring based connectivity.

In one embodiment, the interface unit is arranged for interconnection to another interface unit connected to another external switch unit with a different switching platform, whereby a multi-service switching architecture is provided for the optical network.

The external switch unit may comprise OEO cross-connect switch, a packet switch/router or a STS-1 switch technologies.

In one embodiment, the interface unit is implemented as a single card unit.

In another embodiment, the interface unit is implemented as a multiple cards unit.

In accordance with a second aspect of the present invention, there is provided an optical transport and switching network comprising one or more interface units as claimed in claim 1.

The WDM may comprise dense WDM (DWDM).

The WDM may comprises coarse WDM (CWDM).

In accordance with a third aspect of the present invention, there is provided a method of interfacing between a WDM optical network and a plurality of external switch units having different switching platforms, each external switch unit having at least one associated conversion element connected to it, the method comprising the step of selectively directing optical signals to the conversion elements connected to the respective switch units, and, at the conversion elements, converting one or more layers of a management protocol in the optical signals directed to the respective conversion elements into corresponding layers of a management protocol of the external switch unit connected to the respective conversion elements.

At least preferred embodiments of the invention provide a generic architectural design and a low cost technique or methodology for adapting one vendor's WDM multiplexer technology with other vendors centralized, optical-electrical-optical (OEO) cross-connect switch, packet switch/router and STS-1 switch technologies, and other switch technologies such as Fibre Channel Directors.

The preferred embodiments of the invention have:

Reconfigurable Optical Add/Drop WDM (OADM) WDM-to-switch interfaces for each switch type (with protocol agnostic OEO cross-connect switching providing the reconfigurability capability);

Coarse WDM (CWDM) multiplexing technologies having a ITU G.694.2 standard wavelength grid (CWDM requiring less space, power & cost);

The OADM implemented with two interconnected WDM-to-switch interface cards per switch attachment for increased reliability & surviveability; and

A WDM ring architecture for interconnecting multiple different switch types at a CO and multiple remote WDM multiplexers, Packet switches and TDM multiplexers which interface to a wide range of clients needing both high capacity and low capacity transport and switching services.

### BRIEF DESCRIPTION OF THE DRAWINGS

Preferred embodiments of the present invention will now be described, by way of example only, with reference to the accompanying drawings.

FIG. 1 is a schematic drawing illustrating a point-point WDM-OEO switching and transport network embodying the present invention.

FIG. 2 is a schematic drawing illustrating a point-point WDM-to-OEO switch interface card embodying the present invention.

FIG. 3 is a schematic drawing illustrating a ring-based WDM-OEO switching and transport network embodying the present invention.

FIG. 4 is a schematic drawing illustrating an add/drop WDM-to-OEO-switch interface card-west, embodying the present invention.

FIG. 5 is a schematic drawing illustrating an add/drop WDM-to-OEO-switch interface card-east, embodying the present invention.

FIG. 6 is a schematic drawing illustrating a ring-based WDM packet switching and transport network embodying the present invention.

FIG. 7 is a schematic drawing illustrating an optical add/drop WDM-to-packet switch interface card-west, embodying the present invention.

FIG. 8 is a schematic drawing illustrating an optical add/drop WDM-to-packet switch interface card-east, embodying the present invention.

FIG. 9 is a schematic drawing illustrating a ring-based WDM/STS-1 switching and transport network embodying the present invention.

FIG. 10 is a schematic drawing illustrating an optical add/drop WDM-to-STS-1 switch interface card-west, embodying the present invention.

FIG. 11 is a schematic drawing illustrating an optical add/drop WDM-to-STS-1 switch interface card-east, embodying the present invention.

FIG. 12 is a schematic drawing illustrating an optical add/drop WDM-to-OEO or packet or STS-1 switch interface card embodying the present invention.

FIG. 13 is a schematic drawing illustrating a multi-services metro switching architecture embodying the present invention.

FIG. 14 is a schematic drawing illustrating management interfaces in WDM-to-switch interface cards embodying the present invention.

### DETAILED DESCRIPTION OF THE EMBODIMENTS

The preferred embodiments described achieve the integration of proprietary multi-channel, multi-protocol WDM and OEO technologies onto centralised equipment line cards for various switch/router types (OEO, Packet & STS-1), with maximum technology re-use and thus minimum development and production cost. The preferred embodiment of this invention relates to CWDM interface technologies due to space, power and cost reasons, however, future improvements and integration of DWDM technologies is expected to eventually enable the same level of switch interface integration using DWDM technology.

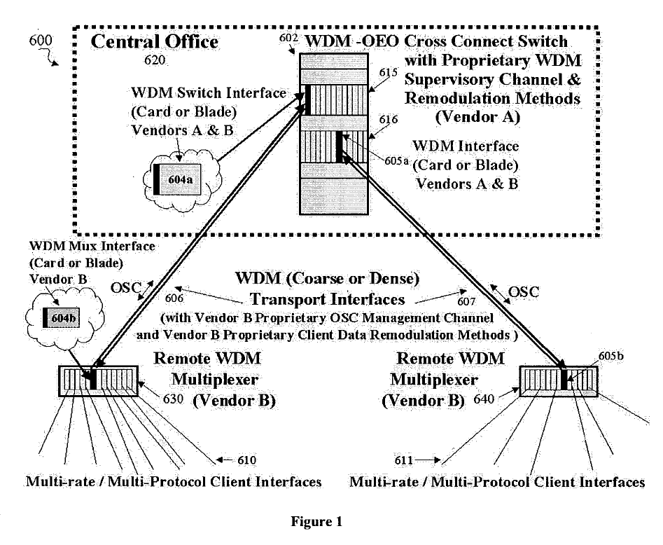

FIG. 1 illustrates the a first integration of proprietary (and eventually standard) WDM multiplexer interfaces (606, 607) from Vendor B into WDM-OEO switch interface cards (604a, 605a) that plug into vendor A's switch (602), embodying the present invention.

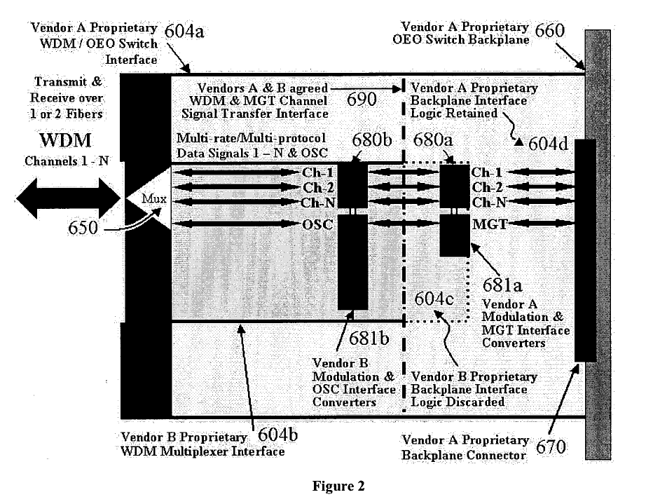

FIG. 2 illustrates a first embodiment of the invention for simple point-to-point network applications (compare FIG. 1). As shown, Vendor A's switch defines the overall size of the OEO switch interface card (604a). The size of Vendor B's WDM multiplexer interface card (604b) is shown as an overlay to the switch interface card. It is a reasonably valid assumption that in most cases, a central OEO switch interface card will be larger than a remote WDM multiplexer interface card. There are ways of using multiple switch card slots if this is not the case. Vendor B's N-channel WDM interface (604b) is shown at the front (left) of the integrated switch interface card (604a) and Vendor A's OEO switch backplane interface (660) and connector(s) (670) are shown at the rear (right) of the integrated switch interface card (604a).

As shown in FIG. 2, there is a WDM multiplexer (Mux) (650) at the front of the switch interface card (604a), which includes both the wavelength multiplexing and demultiplexing functions (to/from the wavelength domain and a spatial domain). This involves for example, WDM optical filters, N×wavelength-specific lasers and N×PIN/APD optical receivers (not shown)(or N+1 lasers & receivers where an optical supervisory channel (OSC) is included for remote management).

The N×WDM channels include transmit and receive paths which may be WDM-multiplexed onto a single fiber strand or multiple fiber strands (generally two). In some asymmetric applications where there is a greater downstream than upstream capacity requirement, it is also feasible to have more WDM lasers than receivers fitted to this switch interface card (or visa versa for greater upstream capacity).

A person skilled in the art would appreciate that the WDM (604b) interface can alternatively emanate from other parts of the switch card (604a), such as from the rear if there is sufficient space and appropriate (optical) backplane connections available. For the purpose of describing this embodiment and all subsequent embodiments will assume that Vendor B's WDM interface is at the front of Vendor A's switch interface card.

As shown in FIG. 2, there is a partitioning of the integrated switch interface card (604a) into two discernible parts with a well defined WDM and Management (MGT) Channel Signal Transfer Interface (690) that separates the two parts. It is up to the two Vendors A & B to agree to the nature of this signal transfer interface (690) and to develop on either or both sides of this interface (690), suitable data channel and OSC-MGT channel converters so that the signal transfer requirements at this interface are met. It is feasible that in the future, such a signal transfer interface (690) could form the basis of a WDM standard.

In this example embodiment, Vendor B may be required to develop modulation and Optical Supervisors Channel (OSC) or Embedded Operations Channel (EOC) interface converters shown as 680b and 681b respectively. Similarly, Vendor A may be required to develop modulation and MGT interface converters shown as 680a and 681a respectively. In some cases, Vendors A and B may agree that only one of the vendors is required to develop the interface converters and the signal transfer interface is in this case defined by signal definitions that already exist within the other vendor's product. As can be seen, there may be a management connection in either or both cases, between the OSC/MGT interface converters (681b, 681a) and the modulation interface converters (680b, 680a). This management connection would be used to configure the modulation converters to adapt to or switch to a different protocol and rate.

As shown in FIG. 2, the section (604d) of Vendor A's switch interface card that interfaces to the switch backplane (660) is retained as vendor A's part of the card. Since Vendor A's part does not need to interface to Vendor B's multiplexer backplane, there is a section (604c) of Vendor B's WDM multiplexer interface (604b) that can be “discarded” from Vendor B's part of the switch interface card, when compared to a full prior art WDM multiplexer card.

It is another characteristic of this invention that the signal transfer interface (690) can be defined at a point which maximizes use of existing intellectual property and associated designs (optical and electronic circuits, printed-circuit board layouts, software etc) from both Vendors A & B and minimizes the amount of new development of modulation and OSC/MGT converters.

The design segregation of the switch interface card (604a) into A & B parts with maximum intellectual property and design re-use within these parts, has the benefits of shorter development time (reduced time to market), lower development risk and cost, clear delineation of intellectual property ownership (a must in the absence of standards) and simple contractual relationships between the two Vendors A & B. This approach is also amenable to the development of a defacto industry standard signal transfer interface, which could subsequently progress to become a widely adopted standard.

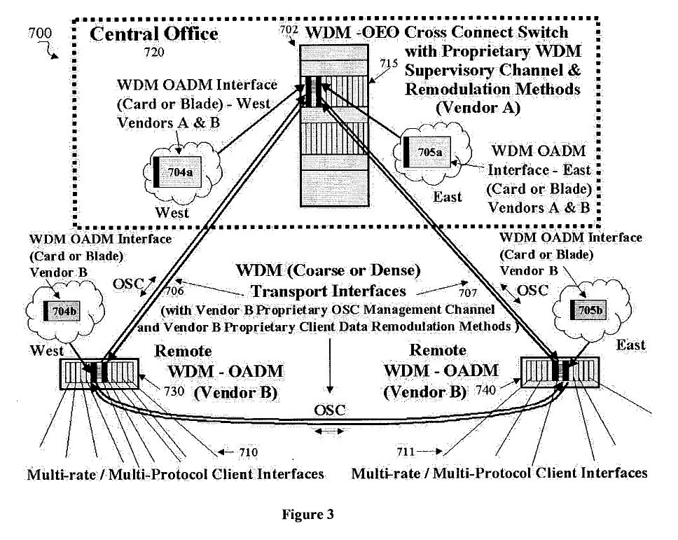

FIG. 3 extends the example embodiment shown in FIGS. 1 and 2 by configuring the remote WDM multiplexers as Optical Add/Drop Multiplexers (OADMs) (730 & 740) and similarly configuring the central switch interface cards (704a, 705a) as an OADM.

Typically, an OADM is implemented by installing two rather than one WDM network interfaces (called west and east interfaces) which are interconnected to enable a through-path for express wavelength channels. The benefit of two OADM interface cards connected as part of a WDM ring is increased reliability and surviveability for both the switch-access and the network. As an option, the remote and/or the central OADMs may include a wavelength switching function. In this case, they are referred to as Reconfigurable OADMs.

The wavelength switching function enables client or tributary interfaces to connect to any of the east or west wavelength channels and may also enable switching of wavelengths between channels as well as broadcasting of data from a channel to multiple client or tributary interfaces.

The wavelength switching function may be implemented using either optical or electrical switching matrices, the preferred embodiment uses an electrical switching matrix since this is consistent with the central WDM-OEO switch architecture and provides all the benefits for electrical switch architectures in general.

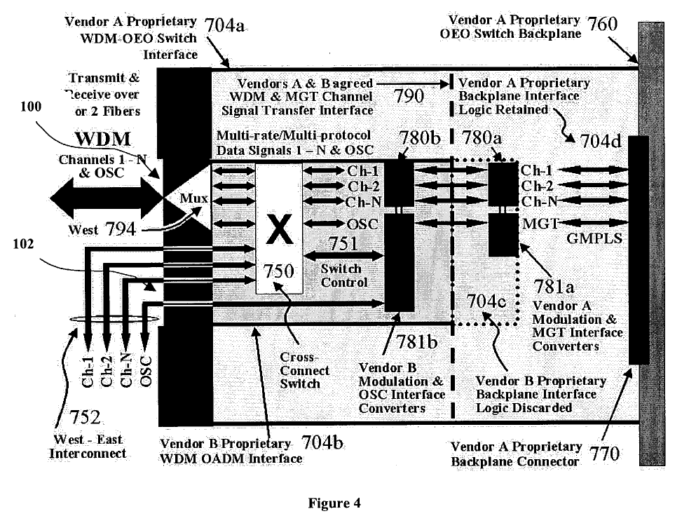

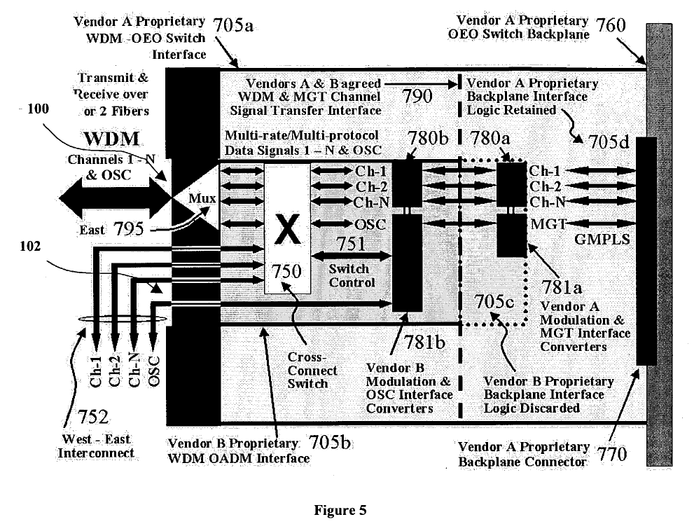

FIG. 4 and FIG. 5 illustrate modifications that may be made to the simple point-point WDM switch interface card (604a) embodiment shown in FIG. 2 to implement reconfigurable OADM switch interface cards west and east (704a, 705a) respectively. These modifications include an electrical, protocol agnostic cross connect switch (750); a switch control interface (751); and a west-east interconnect bus (752) which optionally includes a means of extending the OSC channel between the west and east switch interface cards (704a, 705a). The west-east interconnect bus (752) may for example, be implemented using high-speed electrical interconnects (via cable or backplane) or parallel optical interconnects. As seen from FIGS. 4 and 5, the west and east switch interface cards (704a, 705a) are virtually identical. The exception is the WDM Mux section, which for single-fiber links would implement a west WDM wavelength plan (794) (FIG. 4) and a mutually exclusive east WDM wavelength plan (795).

In the embodiment shown in FIGS. 4 and 5 switch interface segregation into Vendor-specific A & B parts is again employed; an agreed signal transfer interface specification (790); and the optional inclusion of modulation and OSC/MGT interface converters (781a, 781b) are provided.

As shown in FIGS. 4 and 5, a further improvement enabled by the reconfigurable OADM capability, is the inclusion of a standard GMPLS management protocol for configuring connections between central and remote client interfaces, tributary interfaces and WDM channels. This enables the integration of centralised and distributed switching nodes—similar to that provided by GR-303 for TDM switches.

Given that Vendor A's WDM-OEO switch can perform the same OADM switching functionality provided by Vendor B's electrical cross connect switch (750) shown in FIGS. 4 and 5, one option would be to delete this replicated functionality from the switch interface card. However, there are several benefits in retaining this switching functionality on the switch interface card (704a, 705a). These benefits include:

The ability to pass-through ring traffic without consuming the capacity on Vendor A's OEO switch;

The ability to pass through client protocols that are not supported by Vendor A's OEO switch;

Support for broadcast functions that Vendor A's OEO switch might not support;

Option to terminate only a subset of all WDM channels at Vendor A's switch;

Faster ring protection switching capabilities; and

Provision by vendor B of a common reconfigurable OADM interface part for a range of OEO, packet and TDM switches, with minimal extra development cost (as will become evident from the following sections).

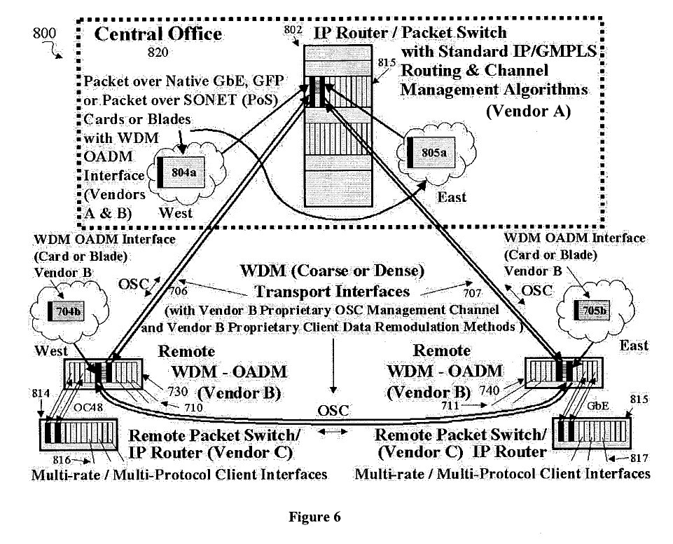

The embodiment shown in FIG. 6 adds a ring-based WDM overlay network to a standard packet switching and transport network shown. Logical point-point connections are formed via WDM channels provided by Vendor B's OADM multiplexers (730, 740) inserted between the remote IP Routers/Packet Switches (814, 815) provided by Vendor C and the centralised IP Router/Packet Switch (802) provided by Vendor A. Interfacing Vendor B's WDM network to Vendor A's IP Router/Packet Switch is provided via a pair of integrated WDM/Packet Switch Interface Cards (804a, 805a)—which are a joint development by Vendors A & B. These two packet switch interface cards (east and west) are shown connected as a OADM configuration. A point-to-point configuration is also possible (compare FIG. 1).

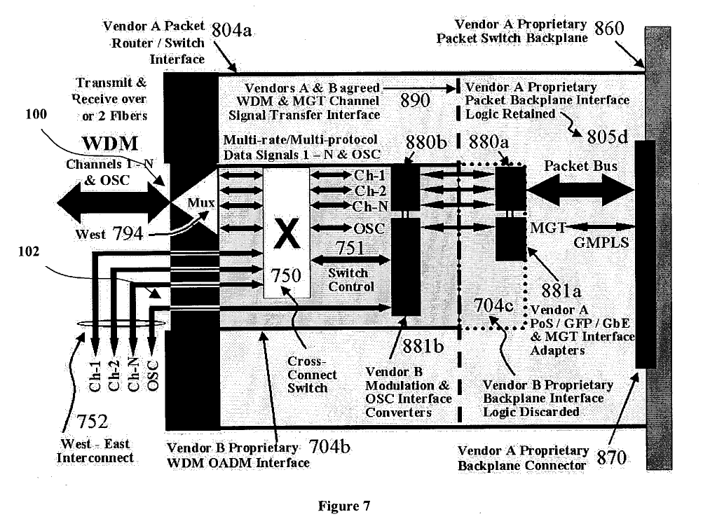

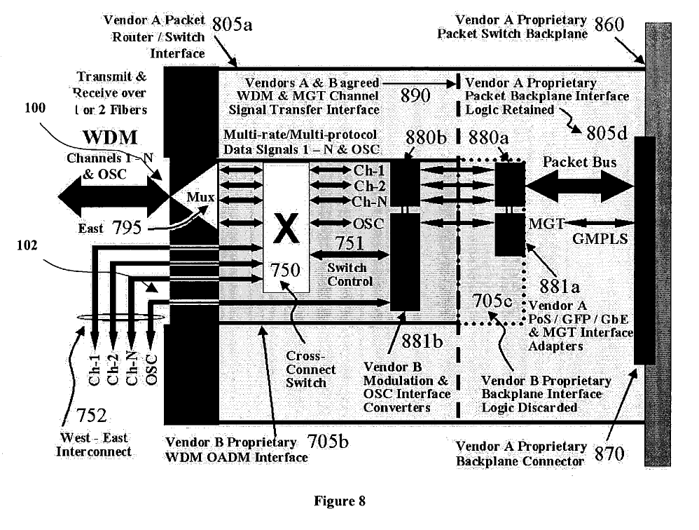

FIGS. 7 and 8 illustrate the preferred embodiment of the centralized Optical Add/Drop WDM Packet Switch Interface Cards (804a, 805a). The difference between these interfaces and those shown in FIGS. 4 and 5 are:

The Signal Transfer Interface specification (890) which in this case is optimized for the packet switching/routing architecture of the central switch;

Vendor B's modulation and OSC interface converters (880b & 881b). (880b may do little more than provide a physical layer conversion);

Vendor A's Packet over Sonet (PoS), Generic Framing Procedure (GFP), Gigabit over Ethernet (GbE) etc packet interface adaptors (880a) which translate or adapt packet data from the switch/router backplane format to the format defined by the agreed Signal Transfer Interface specification (890). On each switch interface card (804a and 805a), there may be up to “N” individually fixed or programmable adaptors (880a) required for each packet data protocol and rate required to be transported over any of the “N” WDM channels available.

Vendor A's MGT interface adaptor (881a) which may for example translate GMPLS messages to a format defined by the agreed Signal Transfer Interface specification (890), which in turn is converted by 881b to Vendor B's OSC protocol and to the 750-switch control signals (751) for switch (750).

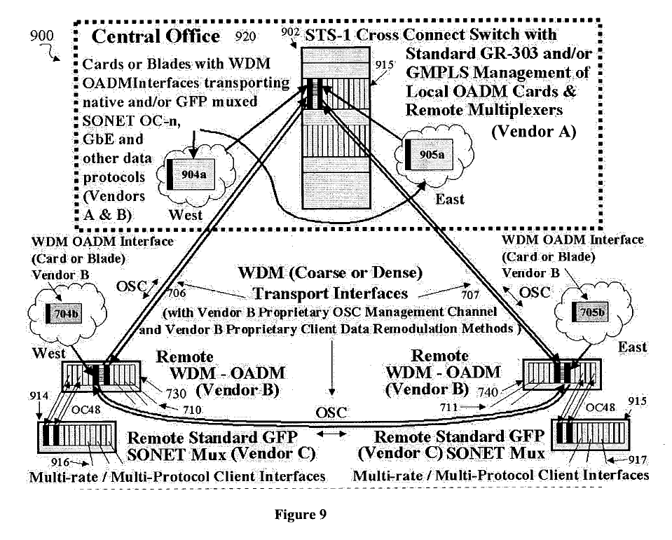

The embodiment shown in FIG. 9 adds a ring-based WDM overlay network to a standard GFP compliant SONET STS-1 switching and transport network. Logical point-point connections are formed via WDM channels provided by Vendor B OADM multiplexers (730, 740) inserted between the remote TDM Multiplexers (914, 915) provided by Vendor C and the centralised STS-1 Switch (902) provided by Vendor A. Interfacing Vendor B's WDM network to Vendor A's STS-1 Switch is provided via a pair of integrated WDM/STS-1 Switch Interface Cards (904a, 905a)—which are a joint development by Vendors A & B. These two STS-1 switch interface cards (east and west) are shown connected as a OADM configuration. A point-to-point configuration is also possible (compare FIG. 1).

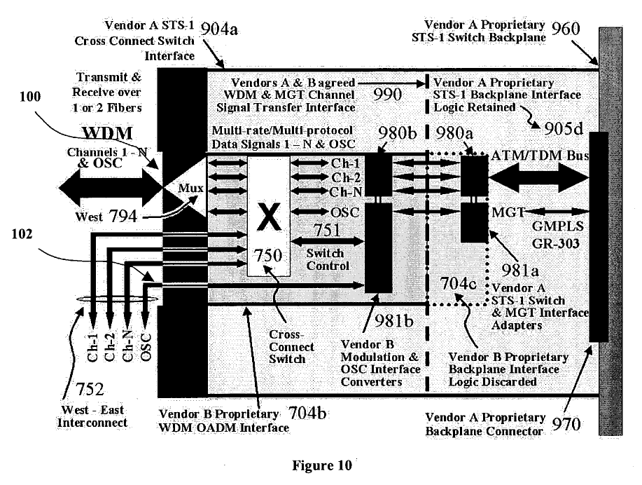

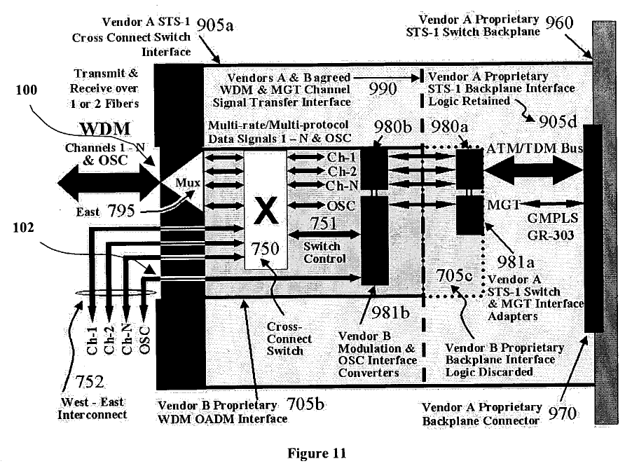

FIGS. 10 and 11 illustrate the preferred embodiment of the centralized Optical Add/Drop WDM Packet Switch Interface Cards (904a, 905a). The difference between these interfaces and those shown in FIGS. 4 and 5 are:

1. The Signal Transfer Interface specification (990), which in this case is optimized for the STS-1 switching architecture of the central switch;

2. Vendor B's modulation and OSC interface converters (980b & 981b). (980b may do little more than provide a physical layer conversion);

3. Vendor A's STS-1 switch interface adaptors (980a) which translate or adapt signal streams from the STS-1 switch backplane format to the format defined by the agreed Signal Transfer Interface specification (990). On each switch interface card (904a and 905a), it is possible that there will be a common, standard STS-n format (such as STS-48) for interfacing to a TDM switch backplane and it will be the responsibility of the remote GFP multiplexers (914, 915 in FIG. 9) to adapt the client interface protocols (916, 917) to a standard SONET OC-48 format for transmission over a WDM channel on links 706, 707 to the central STS-1 switch. Note that this invention equally applies to Synchronous Digital Hierarchy (SDH) multiplex formats, such as STM-16 (equivalent to OC48). The dominant reference to SONET standards throughout this description has been for simplicity only. Other STS-1 switch implementations may include an ATM interface to Vendor A's switch backplane (960) which may affect the nature of the interface adaptors (980a). In this case, it is the responsibility of Vendor A to include within the WDM STS-1 switch interface card (904a, 905a), any translations, adaptations or conversions that are required to conform to the Signal Transfer Interface (990).

4. Vendor A's MGT interface adaptor (981a) which may for example translate GR-303 or GMPLS messages to a format defined by the agreed Signal Transfer Interface specification (990), which in turn is converted by 981b to Vendor B's OSC protocol and control signals (751) to the cross connect switch (750).

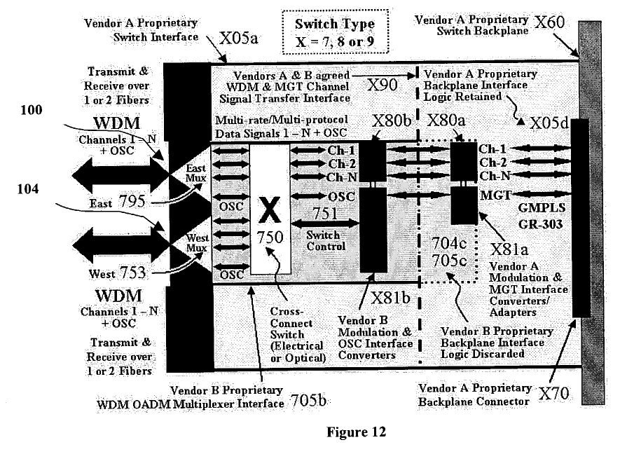

The embodiments of the interface cards described above with reference to FIGS. 4, 5, 7, 8, 10, and 11 are shown as each having a WDM port (100) and a lower-cost interconnect port 102, the latter for connecting to a second interface card for redundancy. However, it is noted that in different embodiments, the interconnect port (102) could be replaced with another WDM port (104) as shown in the embodiment in FIG. 12, for an example WDM switch interface card (X05a). In such an embodiment, east and west WDM filters and transponders (795, 753) are provided on each switch interface card.

If redundancy is not needed, there would be no need for an interconnected second switch interface card in such embodiments, however it is noted that if redundancy was required in such embodiments, then this could be effected by daisy-chaining a second (east/west) switch interface card of the same type.

It will be appreciated by a person skilled in the art that the embodiment illustrated in FIG. 12 can be implemented for all different external switch types discussed above with reference to FIGS. 3 to 11. This has been indicated in FIG. 12 by using the “X” in the reference numerals, which can be substituted by numerals 7, 8 or 9, to refer to corresponding components from the previous embodiments in FIGS. 3 to 11 for different implementations of the embodiment shown in FIG. 12.

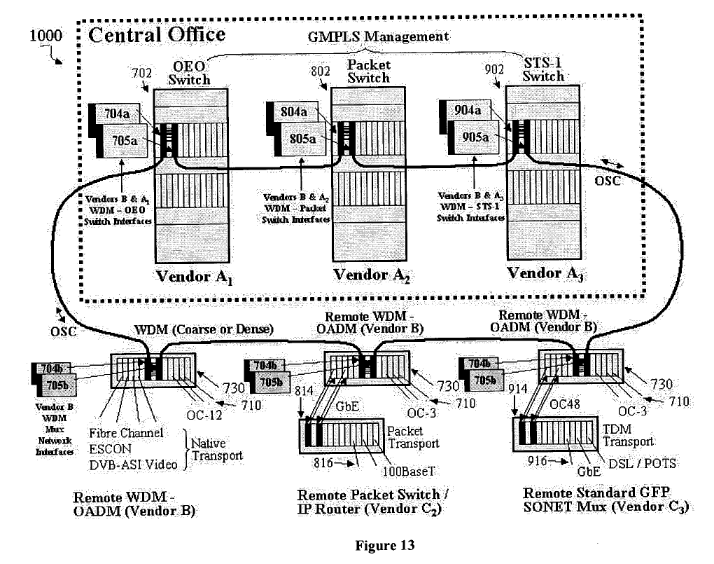

FIG. 13 illustrates the virtual integration of the three previous switching applications (OEO (702), Packet (802) & STS-1 (902)). In this configuration, all three switching applications are co-resident at a CO (1000)—each handling different types of traffic and services (eg, native wavelength services, storage area network services, Internet services, video distribution services and telephone services).

The switching configuration shown in FIG. 13 assumes that each service or groups of services are handled by different switch platforms, each optimized to handle a particular type of service or traffic. Fully integrated prior art switching solutions, involving “god boxes”, are not proving popular due to the disparate growth rates and technology evolution paths of different switching technologies (eg, OOO vs OEO, IP vs MPLS, old TDM standards and GFP).

Using the generic WDM integration techniques of embodiments of this invention for the WDM-OEO, WDM-Packet and WDM-STS-1 switch interfaces, it is possible as shown in FIG. 13 to daisy chain (ie, connect via a WDM ring) all three types of switching platforms to create a virtual “god box” solution that may be managed under a common management framework, such as GMPLS for example. These CO switches may in turn be connected to the remote multiplexers and switches.

A benefit of the virtual “god box” approach is that different switch vendors A₁, A₂ and A₃ can supply different parts of the system, and each part can be independently upgraded or replaced at different times, without affecting other parts of the system.

A benefit of integrating the WDM ring interfaces (704a, 705a, 804a, 805a, 904a, 905a) to the respective switches of different types, is that the WDM ring then provides the “glue” that integrates the three switch types together to form the virtual “god box” as well as providing a means of gathering and distributing traffic from/to the remote WDM OADM multiplexers (730) for native traffic (710) transport and to remote packet switches (814) and TDM multiplexers (914) for aggregating many lower-speed services (816, 916).

Managing the entire metro switching and transport network using a common framework such as GMPLS enables dynamic switching of traffic from the CO to/from remote locations and directly between remote locations (thus bypassing the CO switches when necessary or more efficient).

A benefit of integrating the WDM OADM ring interface into each type of switch using the common integration technique of the embodiments described is lower development cost (especially where the benefit of a full standards based solution is not yet available). Furthermore, pseudo-standardization on a common WDM switch interface architecture and associated “Signal Transfer Interfaces” is likely to accelerate the development of an industry standard and later a more widely accepted standard.

In the following, further consideration is given to the different aspects of data protocol conversion on the one hand, and management protocol conversion on the other hand.

With reference to FIG. 3, in the special case of the OEO switch to CWDM interface cards (704a, 705a), it is feasible that two vendors' products (A & B) could interoperate and thus transfer multi-protocol data transparently from a remote multiplexer (730) to an OEO switch (702) and back to another remote multiplexer (740), without any need for data converters (780b) and (780a) (FIGS. 4 and 5). This is because there is often minimal processing or conversion of each data stream in a WDM multiplexer and an OEO switch and commonly used, high-speed electrical components result in a defacto industry standard approach.

There are exceptions, such as when lower-rate data protocols require special handling to pass through an AC-coupled electrical system. Another example is the extra data processing required to enable the use of sub-carrier (frequency division) or time division multiplexing of multi-protocol data and management protocols over the same WDM wavelengths (referred to as a Embedded Operations Channel or EOC). The latter data/management multiplexing technique avoids the need for an additional (dedicated) wavelength for an Optical Supervisory Channel (OSC) thus potentially reducing network costs and increasing bandwidth efficiency.

In the case of the packet and STS-1 switch options (compare FIGS. 6 and 9 respectively), the increased processing complexity for the data signals results in the necessity for data converters/adaptors, although the emerging GFP standard for multiplexing different data protocols into OC-n streams may eliminate or reduce the complexity of these converters/adaptors on WDM-Switch blades in the future.

In contrast to the data protocols, the management protocols (which are inherently packet based) are generally the last to be standardized. For this reason, it is highly unlikely that two vendors will develop WDM Multiplexer and Switching products that are inter-operable across all seven layers of the Open Systems Interconnection (OSI) protocol model (or stack). As a result, the management interface converters X81b and X81a (X=6, 7, 8, 9) are an essential element for all switch options (see FIGS. 4, 5, 7, 8, 10, 11, 12).

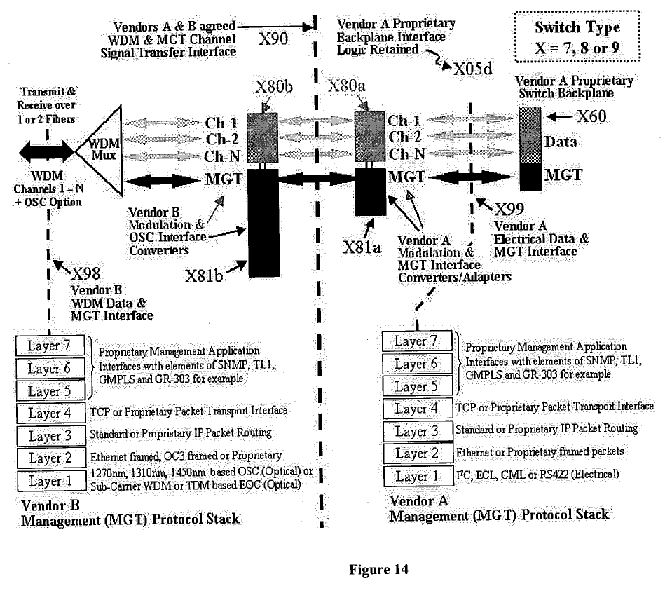

As illustrated in FIG. 14, the proprietary WDM and Switch management protocols are defined at the interface reference points X98 and X99. Each protocol embodies elements of each layer of the 7-layer model (although there may be some null layers in some cases). For different vendors, there may be some commonality across some layers, but rarely will there be commonality across all layers. For example, some vendors may use TCP/IP and Ethernet packet framing, but completely different layer 1 protocols in the optical and/or electrical domains.

The physical layer (1) transport of management signals is often the most proprietary of all layers. This is most true in the case of the sub-carrier EOC multiplexing option. This option generally only supports lower data rates. When this option is used, the EOC data rate is better matched to an electrical backplane interface such as I²C, which like EOC channels, supports only lower data rates.

Greater protocol similarity and chance of standardization is possible for the OSC management channel option with Ethernet (especially 100BaseFX) being a likely contender for a layer 1 and layer 2 optical interface standard for the OSC wavelength at interface reference X98. However, in the electrical domain—at interface reference X99, there is less standardization—especially at layer 1. If the layer 1 data rate and layer 2 packet framing is Ethernet, then layer 1 electrical interfaces can be ECL, CML or RS422 for example. A physical interface converter will required if Vendor A has converted the MGT signal from optical to ECL (Emitter Coupled Logic) and Vendor B is using RS422 for the MGT signal.

The various equipment vendors will also have different parameters to monitor (get) or control (set) and different ways of referring to and acting upon information sent over the management channels. These differences occur between layers 5 and 7. Such differences may be resolved in software on different processor cards fitted to Vendor A's Switch and/or Vendor B's WDM Multiplexer product. However, the higher layers of management protocols such as SNMP or GMPLS may require new control functions that require some translation or interpretation on the WDM-Switch Interface Card. The management converters X81b and X81a may be required to provide this translation or interpretation.

Embodiments of the present invention:

Provide a means for a CO switch to interface directly to and control remote switches and multiplexers via a WDM ring, without the need for costly, book-ended equipment configurations;

Are enabled by low power, space and cost CWDM technologies;

In the absence of standards, provide a means of interfacing to proprietary WDM modulation and optical supervisory management protocols—the requirements of which are complicated and may take some time to achieve standardisation;

Provide an architecture and integration methodology that reduces the development risk, time and cost of interfacing proprietary WDM interfaces to multiple switch types and switch vendors;

Provide a clear delineation between different WDM multiplexer vendors and switch vendors intellectual property (important in the absence of standards);

Provide a mechanism for rapidly developing “signal transfer interface” specifications for each switch type and vendor, which can lead to industry standards faster than would normally be possible and later, to widely accepted standards;

Provide a means of integrating at a CO, several different switch types (OEO, Packet & STS-1) using integrated WDM—switch interface cards (blades) all of which are daisy-chained via the same WDM ring. This approach provides the integration benefits of “god boxes” without the deficiencies of single-source supply and disparate technology evolution.

In the embodiments described above with reference to FIGS. 4 to 12, the cross-connect switch (750) may comprise electrical or optical switch matrices.

It will be appreciated by the person skilled in the art that numerous modifications and/or variations may be made to the present invention as shown in the specific embodiments without departing from the spirit or scope of the invention as broadly described. The present embodiments are, therefore, to be considered in all respects to be illustrative and not restrictive.

For example, while the preferred embodiments have been described as single card units, it will be appreciated that the present invention can be implemented in different ways, including e.g. as multi-card units, or multi-board, single card units.

In the summary of the invention, except where the context requires otherwise due to express language or necessary implication the word “comprising” is used in the sense of “including”, i.e. the features specified may be associated with further features in various embodiments of the invention.

1. A WDM-to-switch interface unit comprising
a WDM multiplexer/demultiplexer (mux/demux) for interfacing to a WDM optical network,
a switch interface element for interfacing to an external switch unit, and
a first conversion component disposed between the WDM mux/demux and the switch interface element for converting one or more layers of a management protocol in the optical network into corresponding layers of a management protocol of the external switch unit.

2. An interface unit as claimed in claim 1, wherein the interface unit further comprises a second conversion component disposed between the WDM mux/demux and the switch interface element for converting a data protocol of the optical network into a data protocol of the external switch unit and vice versa.

3. An interface unit as claimed in claim 1, wherein the first conversion component comprises two separate converter elements,
a first converter element for converting the one or more layers of the management protocol of the optical network into intermediate management signals and vice versa, and
a second converter element for converting the intermediate management signals into the corresponding layers of the management protocol of the external switch unit and vice versa.

4. An interface unit as claimed in claim 2, wherein the second conversion component comprise two separate converter elements,
a first converter element for converting the data protocol of the optical network into intermediate data signals and vice versa, and
a second converter element for converting the intermediate data signals into the data protocol of the external switch unit and vice versa.

5. An interface unit as claimed in claim 1, wherein the first conversion component is arranged for converting the one or more layers of the one management protocol from an optical incoming signal into a corresponding electrical signal.

6. An interface unit as claimed in claim 5, wherein the incoming optical signal is received as a optical supervisory channel signal in a demultiplexed WDM signal from the optical network.

7. An interface unit as claimed in claim 5, wherein the incoming optical signal is received as an embedded supervisory signal on one or more of the channel signals of a demultiplexed WDM signal from the optical network.

8. An interface unit as claimed in claim 2, wherein the interface unit further comprises:
a cross connect switching element disposed between the WDM mux/demux and the second conversion component, and
an interconnection element connected to the cross connect switch,
whereby the interface unit is adapted as an add/drop interface unit for ring based connectivity via the WDM mux/demux and the interconnection element.

9. An interface unit as claimed in claim 8, wherein the interface unit is arranged for interconnection to another interface unit via the interconnection element.

10. An interface unit as claimed in claim 8, wherein the interconnection element is in the form of an electrical interconnection.

11. An interface unit as claimed in claim 8, wherein the interconnection element is in the form of an optical interconnection.

12. An interface unit as claimed in claim 11, wherein the interconnection element is in the form of an additional WDM mux/demux.

13. An interface unit as claimed in claim 8, wherein the cross connect switching element comprises an electrical switch.

14. An interface unit as claimed in claim 11, wherein the cross connect switching element comprises an optical switch.

15. An interface unit as claimed in claim 9, wherein the other interface unit is connected to the same external switch unit for a west-east redundancy ring based connectivity.

16. An interface unit as claimed in claim 9, wherein the interface unit is arranged for interconnection to another interface unit connected to another external switch unit with a different switching platform, whereby a multi-service switching architecture is provided for the optical network.

17. An interface unit as claimed in claim 1, wherein the external switch unit comprises OEO cross-connect switch, a packet switch/router or a STS-1 switch technologies.

18. An interface unit as claimed in claim 1, wherein the interface unit is implemented as a single card unit.

19. An interface unit as claimed in claim 1, wherein the interface unit is implemented as a multiple cards unit.

20. An optical transport and switching network comprising one or more interface units as claimed in claim 1.

21. An optical transport and switching network as claimed in claim 20, wherein the WDM comprises dense WDM (DWDM).

22. An optical transport and switching network as claimed in claim 20, wherein the WDM comprises coarse WDM (CWDM).

23. A method of interfacing between a WDM optical network and a plurality of external switch units having different switching platforms, each external switch unit having at least one associated conversion element connected to it, the method comprising the step of selectively directing optical signals to the conversion elements connected to the respective switch units, and, at the conversion elements, converting one or more layers of a management protocol in the optical signals directed to the respective conversion elements into corresponding layers of a management protocol of the external switch unit connected to the respective conversion elements.
